(19) United States
(12) Patent Application Publication
(10) Pub. No.: US 2013/0346248 A1
(43) Pub. Date: Dec. 26, 2013

(54) METHODS AND ELECTRONIC EXCHANGES FOR FACILITATING A BUYER-DRIVEN TRANSACTION

(71) Applicant: BuyStand, LLC, Durham, NC (US)

(72) Inventors: Ted Rudner Kraus, Memphis, TN (US); Joseph P. Davy, Durham, NC (US); Glenn William Brown, JR., Durham, NC (US); Daniel Friel, Charlotte, NC (US); Philip DeSimone, Chapel Hill, NC (US)

(21) Appl. No.: 13/911,671

(22) Filed: Jun. 6, 2013

Related U.S. Application Data
(60) Provisional application No. 61/663,243, filed on Jun. 22, 2012.

(51) Int. Cl. G06Q 30/06

(52) U.S. Cl. CPC G06Q 30/0623
USPC 705/26.61

(57) ABSTRACT

Methods and electronic exchanges that facilitate buyer-driven transactions are provided. The methods may include receiving at an electronic exchange an offer from a buyer to purchase a product or service at a buyer-determined price. The methods may also include searching seller inventory data or seller capacity data from at least one database to match the offer with at least one seller inventory or seller schedule that includes the product or service. The methods may further include receiving at the electronic exchange an acceptance of the offer from an individual seller whose inventory or schedule is included among the at least one seller inventory or seller schedule. Related electronic exchanges are also described.

### CLAIM OF PRIORITY

The present application claims the benefit of U.S. Provisional Patent Application Ser. No. 61/663,243, filed on Jun. 22, 2012, entitled Systems, Methods, and Electronic Exchanges for Facilitating a Buyer-Driven Transaction, the disclosure of which is incorporated herein in its entirety by reference. Additionally, the present application is related to U.S. patent application Ser. No. ______, filed on ______, entitled Products or Services Demand Analytics Systems and Related Methods and Electronic Exchanges, the disclosure of which is incorporated herein in its entirety by reference.

### FIELD

The present disclosure relates to methods and electronic exchanges for facilitating a transaction that includes a buyer.

### BACKGROUND

Retailers of consumer goods have traditionally reduced their prices on inventory items after demand for the inventory items declines. For example, a retailer may reduce its price on a particular inventory item from a retail price (e.g., a Manufacturer's Suggested Retail Price (MSRP)) to a sale price. Moreover, the retailer may further reduce the price on the particular inventory item from the sale price to a clearance price. Such a retailer is using a seller-driven model for determining its price because the retailer, rather than the buyer, determines the price.

Although the retailer may sell more units of the particular inventory item by reducing the price, the retailer's profit margin typically declines as the retailer reduces the price. Additionally, imprecision in calculating demand and pricing may result in the retailer's reduced price being higher or lower than what the demand from buyers would dictate. For example, if the price is too high, then the retailer may sell too few units and have excess inventory, and buyers may have to wait for a sale for the price to decrease. Alternatively, if the price is too low, then the retailer's profit margin may decrease, unnecessarily.

In contrast with the traditional seller-driven model for determining prices, one example of a buyer-driven marketplace is the Priceline.com® “Name Your Own Price®” model, which allows a buyer to submit a bid for a service such as an airline flight, in return for the buyer's flexibility with regard to certain details (e.g., time, operating airline, etc.) of the airline flight. In other words, the “Name Your Own Price®” model works if a buyer is only concerned with price and is not concerned with specific flight times, airlines, seats, etc.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Various embodiments of the present inventive concepts include methods of facilitating a buyer-driven transaction. The methods may include receiving at an electronic exchange an offer from a buyer to purchase a consumer good (e.g., a product or a service) at a buyer-determined price. The methods may also include searching seller inventory data (or seller capacity data) from at least one database to match the offer with at least one seller inventory (or seller schedule) that includes the consumer good. The methods may further include receiving at the electronic exchange an acceptance of the offer from an individual seller whose inventory (or schedule) is included among the at least one seller inventory (or schedule). The offer from the buyer may be an unconditional offer from the buyer.

According to various embodiments, the consumer good may include a specific consumer good selected by the buyer after the buyer performs an electronic search for one or more consumer goods (e.g., products or services).

In various embodiments, the consumer good may include a specific consumer good electronically suggested to the buyer by at least one of the electronic exchange, the individual seller, and a third party.

According to various embodiments, the methods may further include transmitting an indication to the buyer that the offer has been accepted by the individual seller.

In various embodiments, the contact between the buyer and the individual seller to complete the transaction may include a transmission of payment information from the buyer to at least one of the electronic exchange, the individual seller, and a third party.

According to various embodiments, identification of any seller corresponding to a respective one of the at least one inventory (or schedule) may remain undisclosed to the buyer before the transmittal of the indication to the buyer that the offer to purchase the consumer good at the buyer-determined price has been accepted by the individual seller.

In various embodiments, the at least one inventory (or schedule) may include a plurality of inventories (or schedules) corresponding to a plurality of respective sellers.

According to various embodiments, searching the seller inventory data (or seller capacity data) to match the offer with the at least one seller inventory (or seller schedule) may include searching using at least one of a Stock-Keeping Unit (SKU), a Universal Product Code (UPC), a Global Trade Identifier Number (GTIN), and another unique product or service identifier corresponding to the product or service.

In various embodiments, the methods may further include notifying each seller corresponding to a respective one of the at least one inventory (or schedule) that the offer to purchase the consumer good at the buyer-determined price has been submitted. The methods may also include providing each seller corresponding to a respective one of the at least one inventory (or schedule) with an option to accept the offer to purchase the consumer good at the buyer-determined price with a single selection of an acceptance button. Additionally or alternatively, the methods may include automatically accepting or rejecting the offer to purchase the product or service at the buyer-determined price using a seller selection algorithm.

According to various embodiments, receiving the offer to purchase the consumer good at the buyer-determined price may include receiving the offer at the electronic exchange via one of the following channels: a mobile device, a search website of the electronic exchange, a website of the individual seller, a third party shopping platform, and another affiliated third party.

Methods of facilitating a buyer-driven transaction according to various embodiments may include receiving at an electronic exchange an offer from a buyer to purchase a consumer good (e.g., a product or a service) at a buyer-determined price. The methods may also include searching seller inventory data (or seller capacity data) from at least one database to match the offer with a plurality of seller inventories (or schedules) that each include the consumer good. The methods may further include receiving at the electronic exchange an acceptance of the offer from an individual seller whose inventory (or schedule) is included among the plurality of seller inventories (or schedules). The offer from the buyer may be an unconditional offer from the buyer.

According to various embodiments, the plurality of seller inventories (or schedules) may correspond to a plurality of different respective sellers.

In various embodiments, the methods may further include transmitting an indication to the buyer that the offer has been accepted by the individual seller.

According to various embodiments, searching the seller inventory data (or capacity data) to match the offer with the plurality of seller inventories (or schedules) may include searching using at least one of a Stock-Keeping Unit (SKU), a Universal Product Code (UPC), a Global Trade Identifier Number (GTIN), and another unique product or service identifier corresponding to the product or service.

Methods of facilitating a buyer-driven transaction according to various embodiments may include receiving at an electronic exchange a plurality of offers from a plurality of respective buyers to purchase a consumer good (e.g., a product or a service) at a plurality of respective buyer-determined prices. The methods may also include searching seller inventory data (or seller capacity data) from at least one database to match the plurality of offers with at least one seller inventory (or seller schedule) that includes the consumer good. The methods may further include receiving at the electronic exchange an acceptance of at least one of the plurality of offers from an individual seller whose inventory (or schedule) is included among the at least one seller inventory (or schedule). The plurality of offers from the plurality of respective buyers may be a plurality of unconditional offers from the plurality of respective buyers.

According to various embodiments, the at least one seller inventory (or schedule) may include a plurality of seller inventories (or schedules) that correspond to a plurality of different respective sellers.

In various embodiments, receiving the plurality of offers to purchase the consumer good at the plurality of respective buyer-determined prices may include receiving the plurality of offers at the electronic exchange via at least one of the following channels: a mobile device, a search website of the electronic exchange, a website of the individual seller, a third party shopping platform, and another affiliated third party.

Electronic exchanges for facilitating a buyer-driven transaction according to various embodiments may include a network interface configured to communicate with a network. The electronic exchanges may also include an electronic order book configured to receive, via the network interface, an offer from a buyer to purchase a consumer good (e.g., a product or a service) at a buyer-determined price, and to receive, via the network interface, an acceptance of the offer from an individual seller. The electronic exchanges may further include an inventory processor configured to search seller inventory data (or seller capacity data) to match the offer with at least one seller inventory (or schedule) that includes the consumer good. Also, an inventory (or schedule) of the individual seller may be included among the at least one seller inventory (or schedule). Moreover, the consumer good may be a specific consumer good. For example, the consumer good may be a specific consumer good selected by the buyer after the buyer performs an electronic search for one or more consumer goods. In another example, the consumer good may be a specific consumer good electronically suggested to the buyer by at least one of an electronic exchange, the individual seller, and a third party. The offer from the buyer may be an unconditional offer from the buyer.

According to various embodiments, the network interface may further include a buyer interface that is configured to receive the offer via one of the following channels connected between the buyer and the electronic order book: a mobile device, a search website of a particular electronic exchange, a website of the individual seller, a third party shopping platform, and another affiliated third party. The network interface may also include an inventory interface that is configured to receive the seller inventory data (or capacity data) from a plurality of different sellers and to supply the seller inventory data (or capacity data) to the electronic order book.

In various embodiments, the electronic order book may be further configured to receive, via the network interface, a plurality of offers from a plurality of respective buyers to purchase the consumer good at a plurality of respective buyer-determined prices. Also, the inventory processor may be further configured to search the seller inventory data (or capacity data) to match the plurality of offers with the at least one seller inventory (or schedule) that includes the consumer good. Furthermore, the electronic exchanges may be further configured to receive, via the network interface, an acceptance of at least one of the plurality of offers from the individual seller.

According to various embodiments, the inventory processor may be configured to search the electronic order book for the seller inventory data (or capacity data) to match the plurality of offers with the at least one seller inventory (or schedule) that includes the consumer good.

In various embodiments, the inventory processor may be configured to search a database external to the electronic exchanges for the seller inventory data (or capacity data) to match the plurality of offers with the at least one seller inventory (or schedule) that includes the consumer good.

It is noted that aspects of the invention described with respect to one embodiment may be incorporated in a different embodiment although not specifically described relative thereto. That is, all embodiments and/or features of any embodiment can be combined in any way and/or combination. Applicants reserve the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1A is a schematic illustration of a network that connects buyers and sellers to an electronic exchange, according to various embodiments.

FIG. 1B is a block diagram of the electronic exchange of FIG. 1A, according to various embodiments.

FIG. 1C is a block diagram that illustrates details of an exemplary processor and memory that may be used in accordance with embodiments of the present invention.

FIG. 1D is a block diagram of a network interface of the electronic exchange of FIG. 1A, according to various embodiments.

FIGS. 2A-2H are flowcharts illustrating operations of the electronic exchange of FIG. 1A, according to various embodiments.

FIG. 2I is a diagram illustrating a transaction between a buyer and a seller of FIG. 1A, according to various embodiments.

FIGS. 3A and 3B are flowcharts illustrating operations of the electronic exchange of FIG. 1A including receiving a plurality of offers at the electronic exchange, according to various embodiments.

### DETAILED DESCRIPTION

Specific exemplary embodiments of the inventive concepts now will be described with reference to the accompanying drawings. The inventive concepts may, however, be embodied in a variety of different forms and should not be construed as limited to the embodiments set forth herein. Rather, these embodiments are provided so that this disclosure will be thorough and complete, and will fully convey the scope of the inventive concepts to those skilled in the art. In the drawings, like designations refer to like elements. It will be understood that when an element is referred to as being “connected,” “coupled,” or “responsive” to another element, it can be directly connected, coupled or responsive to the other element or intervening elements may be present. Furthermore, “connected,” “coupled,” or “responsive” as used herein may include wirelessly connected, coupled or responsive.

The terminology used herein is for the purpose of describing particular embodiments only and is not intended to be limiting of the inventive concepts. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will also be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the present inventive concepts.

It will be understood that the term “consumer good” may be used herein to describe an item identifiable by a Stock-Keeping Unit (SKU) and/or a Universal Product Code (UPC). In other words, a consumer good described herein may be a specific consumer good rather than any one of a number of consumer goods that merely fit a general description (e.g., a size-twelve brown dress shoe). Specifically, the consumer good may be a product, and the brand and/or model name/number of the product may be indicated to a prospective buyer of the product before the prospective buyer makes an offer to purchase the product. Additionally or alternatively, the term “consumer good” may be used herein to describe specific services. In other words, a consumer good described herein may refer to a specific service that will be performed by a specific service provider and/or for an item having a specific brand and/or model name/number. For example, a consumer good described herein may refer to a specific rental car company and/or a specific make/model of a vehicle for which a prospective renter can make a rental offer. As another example, a consumer good described herein may refer to a specific housecleaning company and/or a specific housecleaning service (e.g., a one-time housecleaning or a repeated monthly housecleaning) for which a prospective buyer can make an offer.

Exemplary embodiments of the present invention may be embodied as methods and exchanges. Accordingly, exemplary embodiments of the present invention may be embodied in hardware and/or in software (including firmware, resident software, micro-code, etc.). Furthermore, exemplary embodiments of the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some aspects of the present invention may be implemented in a “cloud” computing environment. Cloud computing is a computing paradigm where shared resources, such as processor(s), software, and information, are provided to computers and other devices on demand typically over a network, such as the Internet. In a cloud computing environment, details of the computing infrastructure, e.g., processing power, data storage, bandwidth, and/or other resources are abstracted from the user. The user does not need to have any expertise in or control over such computing infrastructure resources. Cloud computing typically involves the provision of dynamically scalable and/or virtualized resources over the Internet. A user may access and use such resources through the use of a Web browser. A typical cloud computing provider may provide an online application that can be accessed over the Internet using a browser. The cloud computing provider, however, maintains the software for the application and some or all of the data associated with the application on servers in the cloud, i.e., servers that are maintained by the cloud computing provider rather than the users of the application.

Exemplary embodiments of the present invention are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Imperfect (e.g., imprecise) pricing of consumer goods can result in significant lost profits for retailers and can frustrate potential buyers who are uncomfortable with a listed price and may choose to wait for a sale price instead of paying the listed price. In particular, predicting consumer demand (and thus appropriate pricing) can be expensive, slow, and inaccurate. Moreover, the sale of consumer goods at clearance prices and/or in clearance stores or clearance sections of stores (whether online or in physical stores) can damage the brand equity associated with the consumer goods, especially if the consumer goods have a reputation for being upscale/exclusive goods. Various embodiments of the inventive concepts described herein, however, allow buyers to submit offers on specific consumer goods they want to purchase, and allow retailers to increase profit/profit margins and protect brand equity.

According to various embodiments of facilitating a buyer-driven transaction, a buyer may submit an offer to an electronic exchange for a specific consumer good that the buyer wants to purchase. For example, a buyer may submit an offer to a BuyStand™ Exchange for an item identifiable by a Stock-Keeping Unit (SKU) and/or a Universal Product Code (UPC). In particular, the process of facilitating a buyer-driven transaction may include receiving at the electronic exchange the offer from the buyer to purchase the consumer good at a buyer-determined price. For example, the buyer may submit an offer to pay $40.00 for the consumer good. Accordingly, the electronic exchange provides the buyer with the opportunity to drive pricing for the consumer good based on the buyer's perceived value of the consumer good. The electronic exchange thus may incentivize the buyer to take immediate action toward purchasing the consumer good instead of waiting for a seller to reduce the price of the consumer good. Additionally, according to various embodiments of the present inventive concepts, the buyer may submit the offer either with or without a time limit (e.g., one minute, one hour, or one day) for acceptance of the offer.

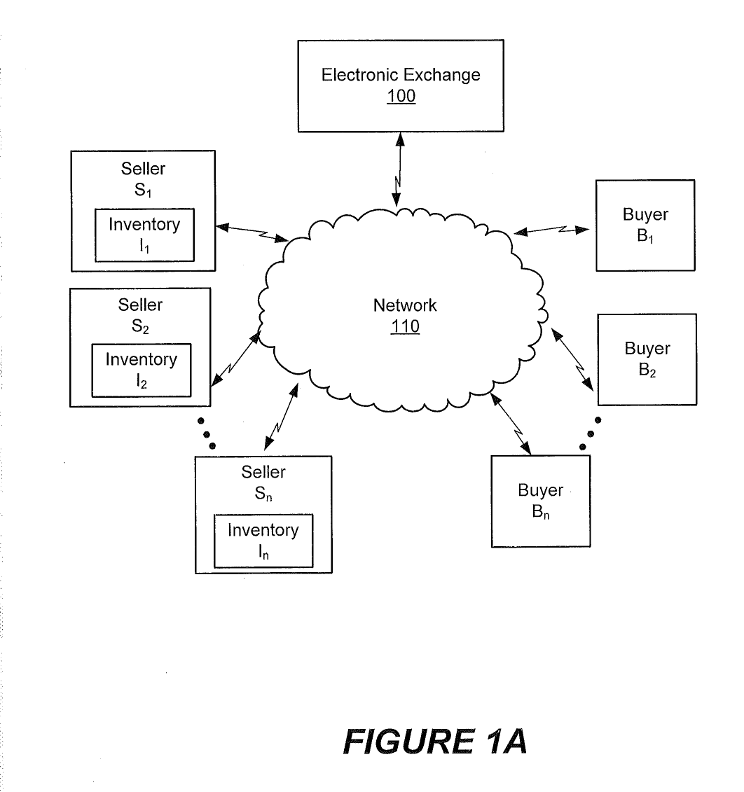

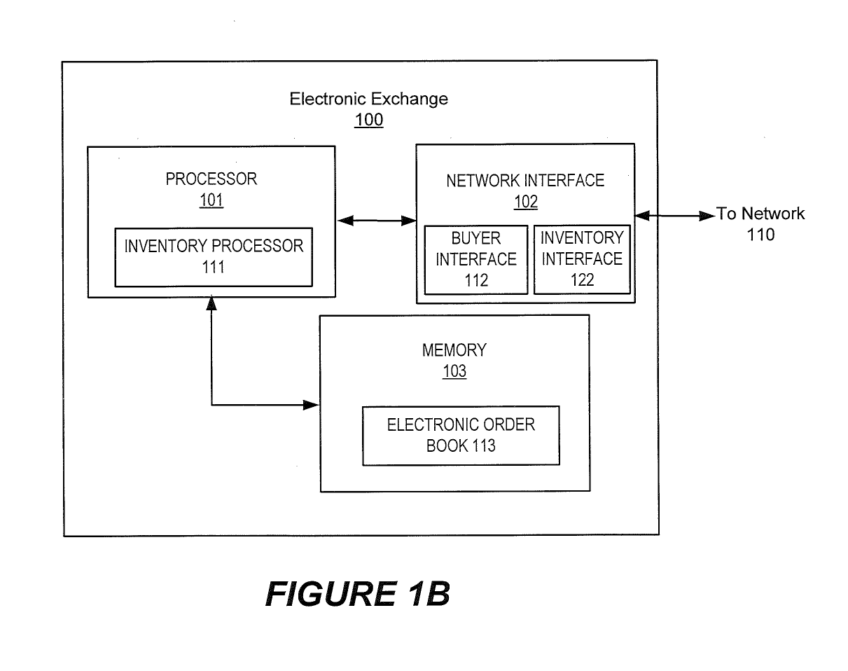

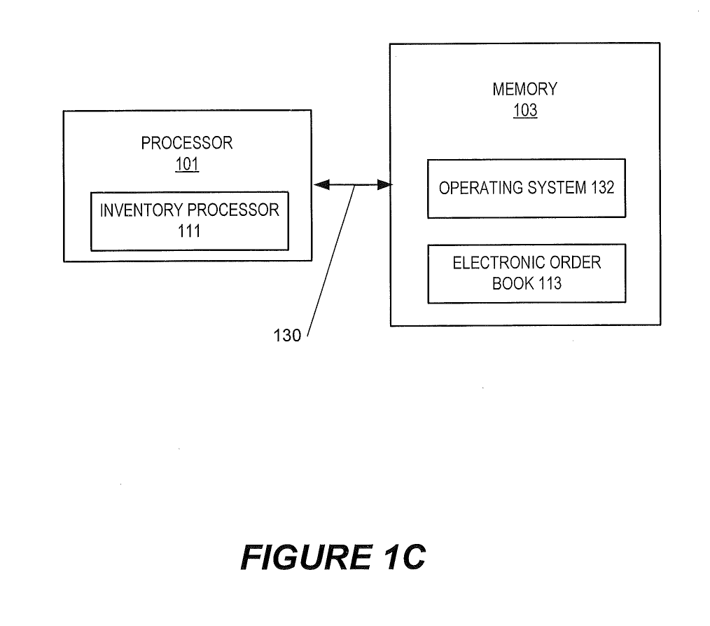

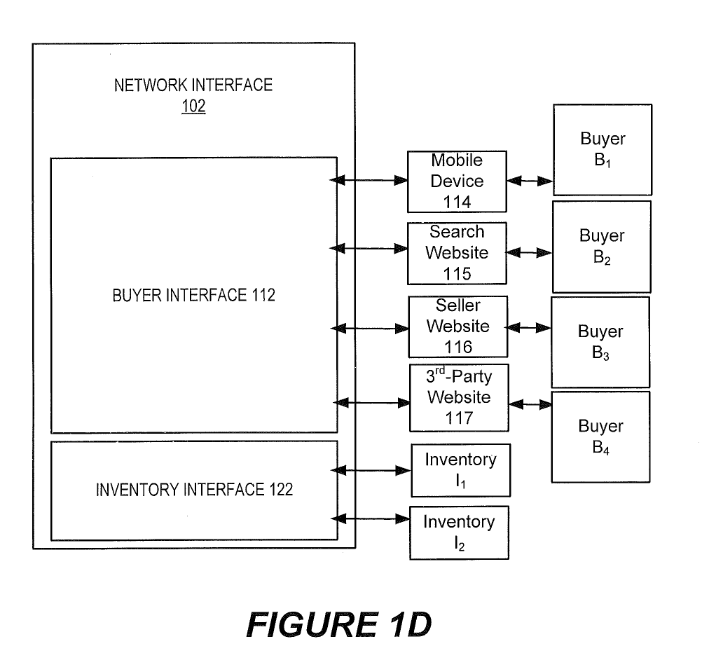

Referring now to FIG. 1A, a schematic illustration is provided of a network 110 that connects buyers B₁-Bₙ and sellers S₁-Sₙ to an electronic exchange 100, according to various embodiments of the present inventive concepts. The network 110 may include the Internet, as well as private networks such as intranets. Additionally or alternatively, the network 110 may include a wireless (e.g., cellular or WLAN) network and/or a wired (e.g., cable or fiber optic) network. The buyers B₁-Bₙ may connect to the network 110 using electronic devices such as computers, televisions, and/or mobile phones. The computers may include desktop, laptop, netbook, tablet computers, and the like. The sellers S₁-Sₙ may have respective inventories I₁-Iₙ, which may be stored electronically in databases operated by the sellers S₁-Sₙ or by third parties. For example, the sellers S₁-Sₙ may be retailers having respective inventories of consumer goods, which may be stored electronically in servers. Moreover, it will be understood that a buyer B described herein shall refer to any one of the buyers B₁-Bₙ. Similarly, a seller S shall refer to any one of the sellers S₁-Sₙ, and an inventory I shall refer to any one of the inventories I₁-Iₙ. Additionally, the term “inventory” may be used herein to refer to both an inventory of products and a schedule of services provided by a service provider. For example, an inventory I may refer to a housecleaning service's schedule of days, times, personnel, and/or specific services open/available to a prospective buyer B. Accordingly, the term “inventory data” may be used herein to refer to both inventory data for one or more products and to capacity data corresponding to schedule capacity/availability for one or more services/service providers.

Referring now to FIG. 1B, a block diagram is provided of the electronic exchange 100 of FIG. 1A, according to various embodiments. In particular, FIG. 1B illustrates that the electronic exchange 100 may include a network interface 102 that is configured to provide a communication interface with the network 110. The communication interface may be for wired and/or wireless communications with the network 110. The electronic device 100 may further include a processor 101 that is coupled to the network interface 102. The processor 101 may be configured to communicate with the buyers B₁-Bₙ and sellers S₁-Sₙ via the network interface 102. For example, the network interface 102 may include a buyer interface 112 for communicating with the buyers B₁-Bₙ. As an example, the buyer interface 112 may be configured to receive offers to purchase consumer goods from the buyers B₁-Bₙ and/or to transmit acceptances by the sellers S₁-Sₙ of the offers to the buyers B₁-Bₙ. The network interface 102 may also include an inventory interface 122 for receiving inventory data from the inventories I₁-Iₙ. The processor 101 may include an inventory processor 111 that is configured to process inventory data received from the inventories I₁-Iₙ through the inventory interface 122. Moreover, it will be understood that the buyer interface 112 and the inventory interface 122 may be separate interfaces or may be combined as a single interface.

The electronic exchange 100 may also include a memory 103 that is coupled to the processor 101. The memory 103 may include an electronic order book 113 that receives and stores offers from the buyers B₁-Bₙ to purchase consumer goods at prices determined by the buyers B₁-Bₙ. For example, the electronic order book 113 may be configured to receive, via the network interface 102, an offer from a buyer B to purchase a consumer good at a buyer-determined price. As an example, the buyer B may submit an offer to purchase a golf club at a buyer-determined price of $40.00. The buyer-determined price may be a price entered using a user interface of an electronic device used by the buyer B. As an example, the buyer B may enter or select a buyer-determined price of $40.00 using a keypad, touch screen, cursor, or microphone. The electronic order book 113 may also receive and store inventory data corresponding to the sellers S₁-Sₙ. For example, the inventory data may include inventory data received from the inventories I₁-Iₙ. Moreover, the inventory processor 111 may be configured to search seller inventory data to match the buyer B's offer with at least one seller inventory I that includes the consumer good. For example, the inventory processor 111 may be configured to search for (or filter/process) inventory data in the electronic order book 113 or inventory data external to the electronic exchange 100 to match the buyer B's offer with at least one seller inventory I. Furthermore, the electronic order book 113 may be configured to receive, via the network interface 102, an acceptance of the buyer B's offer from an individual seller S, such as the seller S₁.

The memory 103 may also store instructions/algorithms used to match offers from the buyers B₁-Bₙ and inventory data received from the inventories I₁-Iₙ. For example, the instructions/algorithms may be used to compare and link together offers from the buyers B₁-Bₙ and inventory data received from the inventories I₁-Iₙ. Moreover, it will be understood that the electronic exchange 100 may include a single processor or a combination of processors. In particular, the electronic exchange 100 may be used in a cloud computing environment. For example, the electronic order book 113 may be distributed/stored among different servers/processors.

FIG. 1C is a block diagram that illustrates details of an exemplary processor and memory that may be used in accordance with embodiments of the present invention.

FIG. 1C illustrates an exemplary processor 101 and memory 103 of an electronic exchange 100, according to some embodiments of the present invention. The processor 101 communicates with the memory 103 via an address/data bus 130. The processor 101 may be, for example, a commercially available or custom microprocessor. Moreover, it will be understood that the processor may include multiple processors. The memory 103 is representative of the overall hierarchy of memory devices containing the software and data used to implement various functions of an electronic exchange 100 as described herein. The memory 103 may include, but is not limited to, the following types of devices: cache, ROM, PROM, EPROM, EEPROM, flash, SRAM, and DRAM.

As shown in FIG. 1C, the memory 103 may hold various categories of software and data, such as an operating system 132 and/or an electronic order book 113. The operating system 132 controls operations of an electronic exchange 100. In particular, the operating system 132 may manage the resources of an electronic exchange 100 and may coordinate execution of various programs (e.g., the electronic order book 113) by the processor 101.

Referring now to FIG. 1D, a block diagram is provided of the network interface 102 (illustrated in FIG. 1B) of the electronic exchange 100 of FIG. 1A, according to various embodiments. FIG. 1D illustrates that the buyer interface 112 of the network interface 102 provides an interface with a variety of different channels 114-117, which may be used by the buyers B₁-Bₙ to make offers for consumer goods at buyer-determined prices. Accordingly, referring to FIGS. 1A-1D, the channels 114-117 are connected between the buyers B₁-Bₙ (illustrated in FIG. 1A) and the electronic order book 113 (illustrated in FIG. 1B) of the electronic exchange 100. The channels 114-117 may include a mobile device 114, a search website (or proprietary search portal) 115 of the electronic exchange 100, a seller website 116, and/or a website of a third party (e.g., a financial institution) 117. The search website 115 of the electronic exchange 100 may include a search engine. Also, the seller website 116 may be a website of an individual one of the sellers S₁-Sₙ.

Each of the channels 114-117 may display an indication to a buyer B that the buyer B can submit an offer to purchase a consumer good at a buyer-determined price. For example, the website of the third party 117 may display a “Make An Offer” button to the buyer B, thus indicating that the buyer B can submit an offer to purchase a consumer good advertised on the third party's website 117. In another example, instead of displaying a discounted price for a consumer good, a seller website 116 may display a “Make An Offer” button to the buyer B. In a further example, the buyer B may use the mobile device 114 by using a mobile application on a portable electronic device to scan a barcode or to access information about a specific consumer good via a keyword search, a menu for a viewing a collection of consumer goods, etc. A mobile application, in accordance with various embodiments of the present inventive concepts, may be specific to an individual seller S or may connect the buyer B to consumer goods from a plurality of the sellers S₁-Sₙ. After the buyer B selects/identifies a specific consumer good using a mobile application, the mobile application may provide the buyer B with an indication, such as a “Make An Offer” button, informing the buyer B that the buyer B can submit an offer to purchase the consumer good at a buyer-determined price. In yet another example, the buyer B may use a keyword search or a menu of the electronic exchange 100's search website 115 to select/identify a consumer good and then submit an offer to purchase the consumer good via the search website 115.

Although FIG. 1D illustrates that the buyers B₁-B₄ are using/connected to the channels 114-117, respectively, it will be understood that each of the buyers B₁-B₄ may be capable of using more than one of the channels 114-117, and that more than one of the buyers B₁-B₄ may use a particular one of the channels 114-117 simultaneously (or substantially simultaneously). For example, the buyer interface 112 may be configured to receive an offer for a consumer good from a buyer B via any one of the mobile device 114, the search website 115 of the electronic exchange 100, the seller website 116 (e.g., a website of the seller S₁), and the third party's website 117. As an example, the buyer interface 112 may be configured to receive an offer for a consumer good from a buyer B₁ via the search website 115, and may be further configured to receive an offer for the same consumer good and/or a different consumer good from a different buyer B₂ via the same search website 115 substantially simultaneously. For example, the offers may be received within a few seconds of each other. Accordingly, the electronic order book 113 may be configured to receive, via the channels 114-117 and the network interface 102 (e.g., the buyer interface 112), a plurality of offers from a plurality of respective buyers B₁-Bₙ to purchase a particular consumer good at a plurality of respective buyer-determined prices.

Referring still to FIG. 1D, the inventory interface 122 may be configured to receive seller inventory data from the inventories I₁ and I₂ from a plurality of different respective sellers S₁ and S₂ and to supply the seller inventory data to the electronic order book 113 using the inventory processor 111 illustrated in FIG. 1B. Each of the plurality of sellers S₁-Sₙ may be a different seller S. For example, two different sellers S₁ and S₂ may be competing retailers or may be different branches/subsidiaries/affiliates of the same parent retailer. Moreover, the inventory processor 111 may be configured to search the seller inventory data in the electronic order book 113 (or in databases external to the electronic exchange 100) to match a plurality of offers from a plurality of respective buyers B₁-Bₙ with at least one seller inventory I that includes the consumer good. Furthermore, an individual seller S may accept one or more of the plurality of offers, and the electronic exchange 100 may be configured to receive, via the network interface 102, the acceptance of the offer(s) from the individual seller S. The electronic exchange 100 may receive the acceptance via the inventory interface 122 or a separate communications interface of the network interface 102.

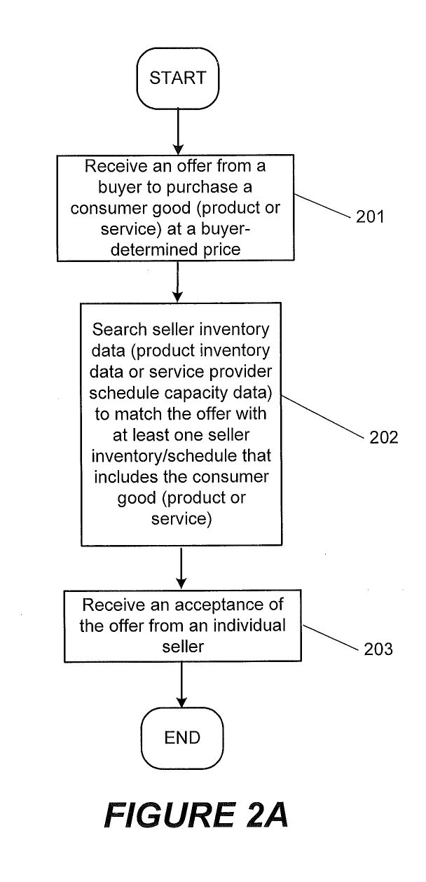

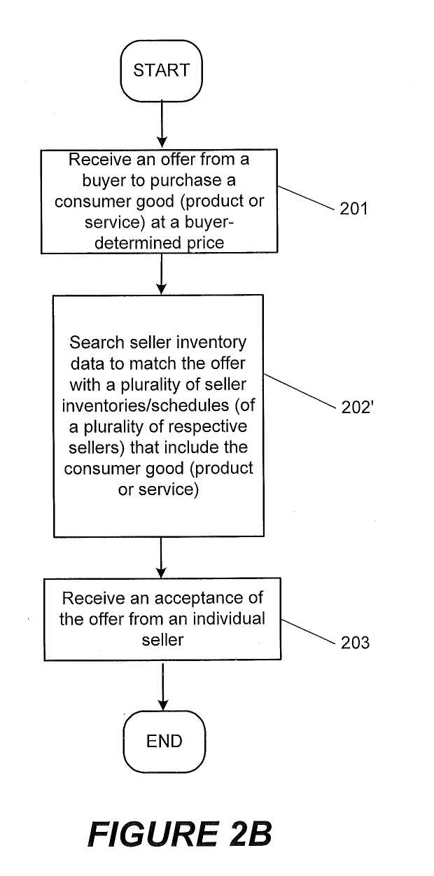

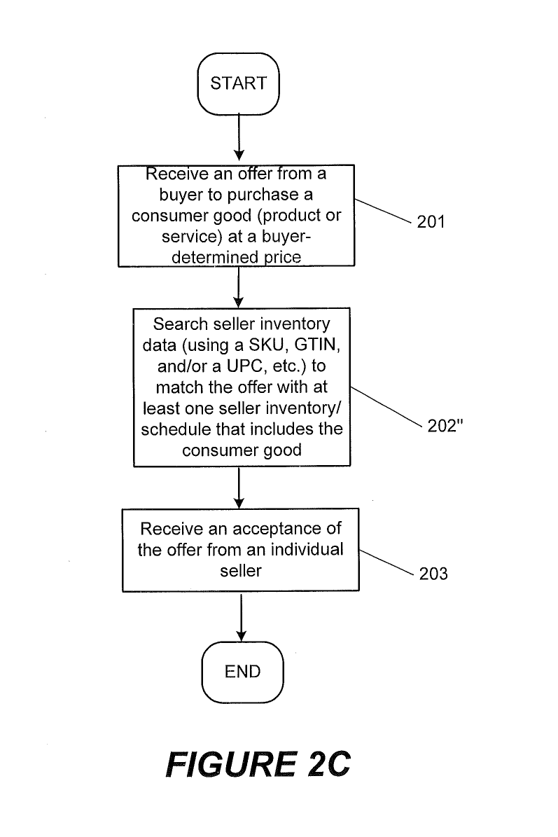

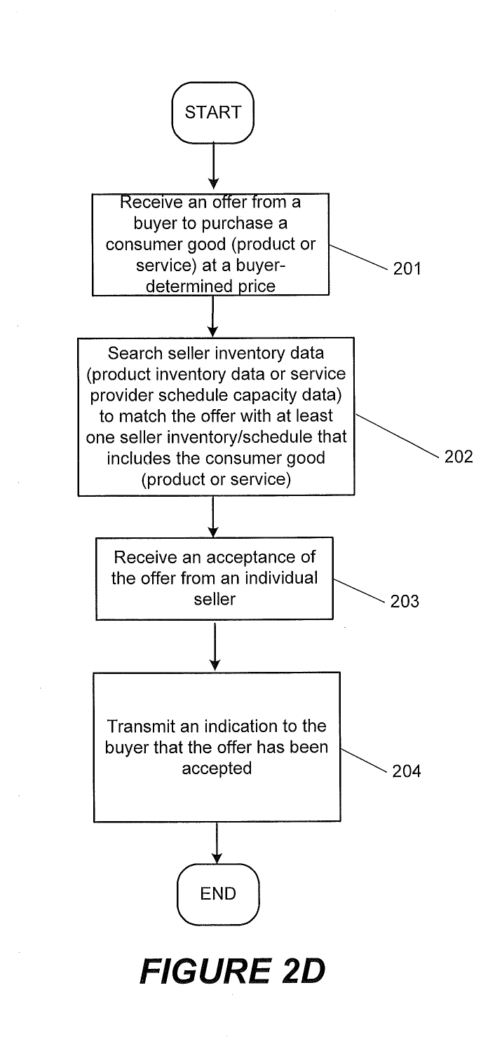

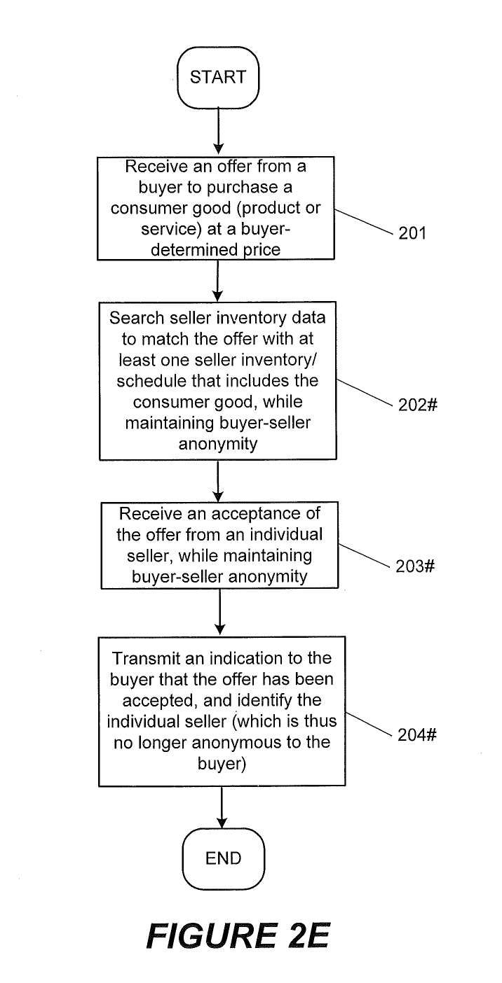

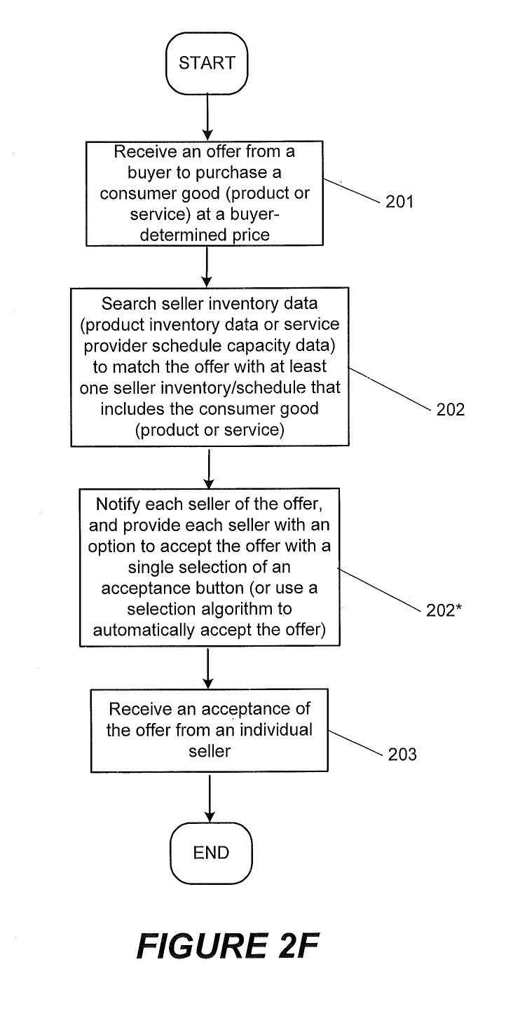

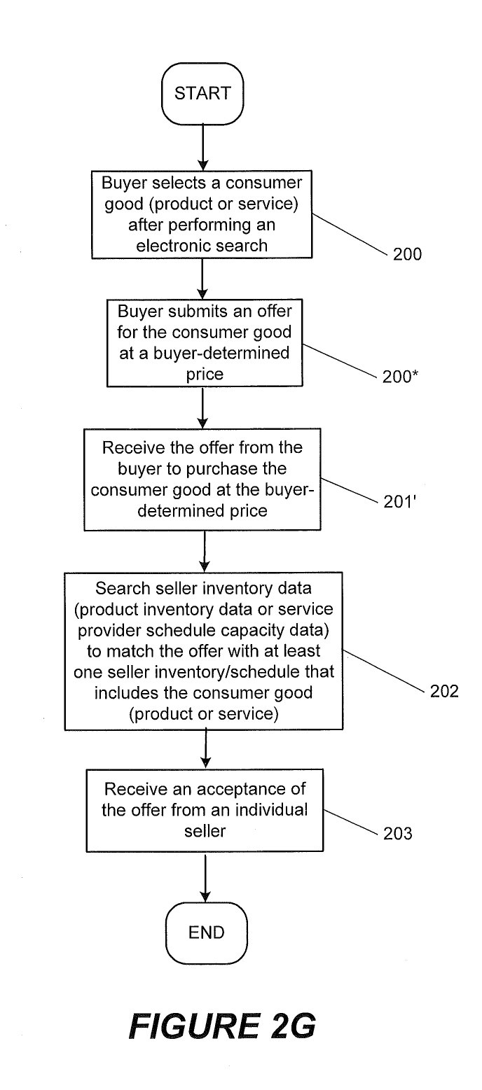

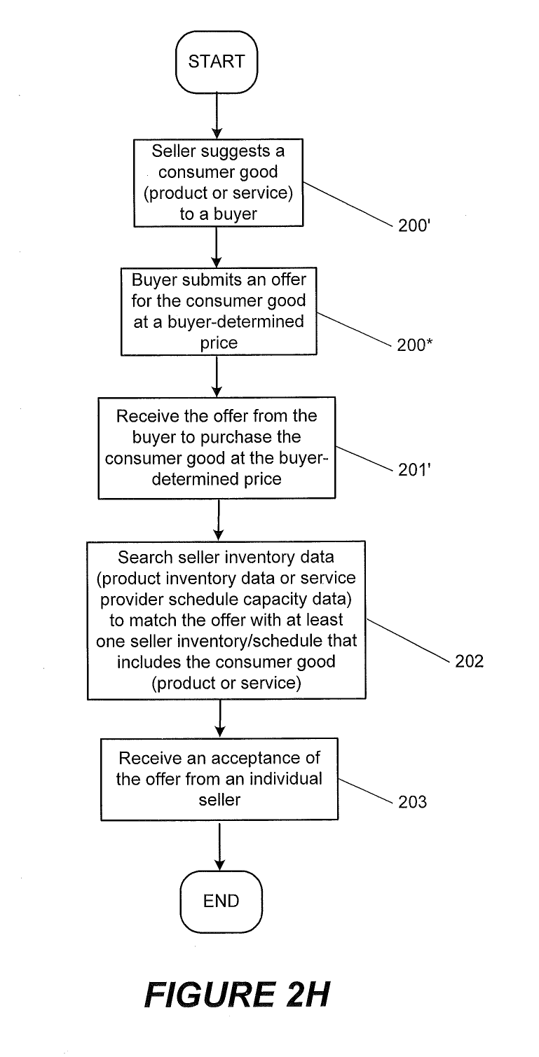

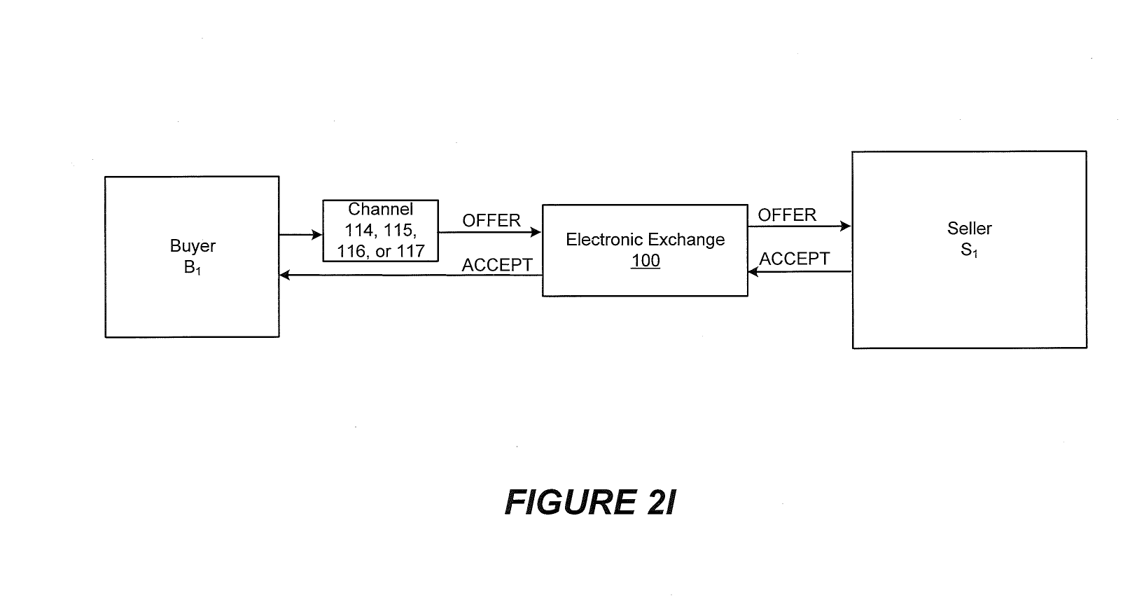

FIGS. 2A-2H are flowcharts illustrating operations of the electronic exchange 100 of FIG. 1A, according to various embodiments. Referring now to FIG. 2A, operations of the electronic exchange 100 may include receiving at the electronic exchange 100 an offer from a buyer B to purchase a consumer good at a buyer-determined price (Block 201). The offer from the buyer B may be an unconditional offer (although it may optionally have a time limit). In other words, the offer may be binding on the buyer B upon the buyer B's submission of the offer, rather than being conditioned upon the buyer B's subsequent acceptance of a counter-offer from a seller S. The operations of the electronic exchange 100 may also include searching for (or filtering/processing) seller inventory data from at least one database to match the offer with at least one seller inventory (e.g., at least one of the inventories that includes the consumer good (Block 202). Moreover, it will be understood that if the buyer B submits the offer using a website 116 or mobile application of an individual seller S, then searching seller inventory data may include matching/recording the buyer B's offer with the seller S's inventory I in the electronic order book 113 without searching the inventories of other sellers. The operations of the electronic exchange 100 may further include receiving at the electronic exchange 100 an acceptance of the offer from an individual seller S whose inventory I is included among the inventories searched by the electronic exchange 100 (Block 203).

Referring now to FIG. 2B, FIG. 2B includes Blocks 201 and 203 of FIG. 2A, and further includes Block 202′, which is a modification of Block 202 of FIG. 2A. In particular, Block 202′ indicates searching seller inventory data to match the buyer B's offer with a plurality of the inventories I₁-Iₙ corresponding to a plurality of the respective sellers S₁-Sₙ. For example, the inventories I₁ and I₂ may each include the consumer good for which the buyer B has provided the offer at the buyer-determined price, and the electronic exchange 100 may thus match the buyer B's offer with each of the inventories I₁ and I₂. Moreover, the electronic exchange 100 may notify the sellers S₁ and S₂ corresponding to the inventories I_{I} and I₂ including the consumer good that the offer has been made for the consumer good at the buyer-determined price. For example, the electronic exchange 100 may notify the sellers S₁ and S₂ via email, via text message, via a website, or via another notification mechanism.

Referring now to FIG. 2C, FIG. 2C includes Blocks 201 and 203 of FIG. 2A, and further includes Block 202″, which is a modification of Block 202 of FIG. 2A. In particular, Block 202″ indicates searching seller inventory data to match a buyer B's offer by searching using at least one of a Stock-Keeping Unit (SKU), a Universal Product Code (UPC), a Global Trade Identifier Number (GTIN), and another unique product (or service) identifier corresponding to the consumer good for which the buyer B has provided the offer at the buyer-determined price. In other words, the electronic exchange 100 may search for the consumer good by the SKU, UPC, GTIN, and/or another product (or service) identifier rather than by a general category/description (e.g., a size-twelve brown dress shoe). For example, the electronic exchange 100 may search for the consumer good in the inventories I₁-Iₙ by searching data from the inventories I₁-Iₙ for the SKU, UPC, GTIN, other product (or service) identifier corresponding to the consumer good. Searching data may include searching in databases external to the electronic exchange 100 or searching in the electronic order book 113. The electronic exchange 100 may then notify the sellers S₁-Sₙ corresponding to the inventories I₁-Iₙ that include the consumer good that the offer has been made for the consumer good at the buyer-determined price.

Referring now to FIG. 2D, FIG. 2D includes Blocks 201-203 of FIG. 2A, and further includes Block 204, which indicates transmitting an indication to a buyer B that the offer for the consumer good at the buyer-determined price has been accepted by an individual seller S. In other words, the electronic exchange 100 may match the buyer B's offer with the inventory I of the seller S, receive an acceptance of the offer from the seller S, indicate to the buyer B that the seller S has accepted the offer.

Referring now to FIG. 2E, FIG. 2E includes Block 201 of FIG. 2D, and further includes Blocks 202#, 203#, and 204#, which are modifications of Blocks 202-204, respectively, of FIG. 2D. In particular, Blocks 202# and 203# indicate performing the operations of Blocks 202 and 203 of FIG. 2D while maintaining anonymity between at least one of a buyer B and a seller S. In other words, at least one of the buyer B and the seller S may remain anonymous to the other of the buyer B and the seller S in Blocks 202# and 203#. For example, identification of the seller S corresponding to the inventory I may remain undisclosed to the buyer B before the transmittal (Block 204#) of the indication to the buyer B that the offer to purchase the consumer good at the buyer-determined price has been accepted by the seller S. Identification of other sellers S₁-Sₙ corresponding to the inventories I₁-Iₙ may also remain undisclosed. As such, sellers S₁-Sₙ may remain anonymous to the buyer B until after an individual seller S accepts the buyer B's offer to purchase a consumer good at a buyer-determined price.

Specifically, the electronic exchange 100 may search seller inventory data to match the offer with at least one seller inventory (among the inventories I₁-Iₙ) that includes the consumer good, while maintaining anonymity between the buyer B and the sellers S₁-Sₙ corresponding to the inventories I₁-Iₙ (Block 202#). In other words, the electronic exchange 100 may not disclose the buyer B's identity to the sellers S₁-Sₙ, and may not disclose the identities of the sellers S₁-Sₙ to the buyer B. Additionally, the electronic exchange 100 may receive an acceptance of the offer from an individual one of the sellers S₁-Sₙ (e.g., from the seller S₁), while maintaining anonymity between the buyer B and the individual seller S₁ (Block 203#). After receiving the seller S₁'s acceptance of the offer, the electronic exchange 100 may transmit an indication to the buyer B that the offer has been accepted by the seller S₁ (Block 204#). The indication may optionally also indicate that the buyer B must contact the seller S₁ to complete the transaction. The indication transmitted to the buyer B thus may include an identification of the seller S₁ to the buyer B. For example, the identification may include the seller S₁'s name, logo, website, phone number, mailing address, and/or email address. The seller S₁'s name may include a legal name, online user/screen name, or company/corporate name or nickname.

Referring now to FIG. 2F, FIG. 2F includes Blocks 201, 202, and 203 of FIG. 2A. FIG. 2F further includes Block 202*, which indicates notifying each one of the sellers S₁-Sₙ having an inventory (among the inventories I₁-Iₙ) that includes the consumer good that the buyer B's offer to purchase the consumer good at the buyer-determined price has been submitted. For example, if the inventories I₁ and I₂ of the respective sellers S₁ and S₂ include the consumer good, then the electronic exchange 100 may send the buyer B's offer in an email or text message to each of the sellers S₁ and S₂. As an example, the electronic exchange 100 may send the buyer B's offer via the network interface 102 in a Short Message Service (SMS) or Multimedia Messaging Service (MMS) message to each of the sellers S₁ and S₂. Additionally or alternatively, the electronic exchange 100 may post the offer on a website that the sellers S₁ and S₂ can access. For example, the website may be a website that receives offer information from the electronic order book 113 illustrated in FIG. 1B.

Referring still to Block 202*, the notification of the offer may indicate the buyer-determined price as well as the consumer good. For example, if the inventories I₁ and I₂ of the respective sellers S₁ and S₂ include the consumer good, then the notification of the offer may indicate a buyer-determined price of $40.00, as well as a description of the consumer good and/or the SKU/UPC corresponding to the consumer good, to the sellers S₁ and S₂. Moreover, the notification may indicate a time limit for accepting the offer. As an example, the time limit may be one minute, one hour, or one day, etc. Additionally, the notification may provide each of the sellers S₁ and S₂ with an option to accept the offer at the buyer-determined price with a single selection of an acceptance button within a user interface, such as a Graphical User Interface (GUI). For example, each of the sellers S₁ and S₂ may have the opportunity to accept the offer by clicking (or touching or otherwise selecting) an acceptance button on a website or mobile application or in an email. As an example, an acceptance button may be in an email from the electronic exchange 100. Accordingly, a seller S may have the option to manually accept the offer. Additionally or alternatively, a seller S may have the option to use a seller selection algorithm that automatically accepts or rejects the offer for the seller S, which allows the seller S to accept or reject the offer without having to use a GUI or to otherwise make a manual selection. After one of the sellers S₁ and S₂ has accepted the particular offer from the particular buyer B, however, no other seller S can accept the particular offer.

Referring now to FIG. 2G, FIG. 2G includes Blocks 202 and 203 of FIG. 2A, and further includes Blocks 200 and 200*. FIG. 2G also includes Block 201′, which modifies Block 201 of FIG. 2A to acknowledge the preceding Blocks 200 and 200*. Block 200 indicates that a buyer B may select a specific consumer good after performing an electronic search for one or more consumer goods. For example, the buyer B may perform an electronic search for a consumer good using one of the channels 114-117. As an example, the buyer B may type a description, such as a general description or a product name/number, of a consumer good into the search website 115. In another example, the buyer B may perform the electronic search by navigating menus of the mobile device 114 or the seller website 116. The menus may include different categories (e.g., clothing, books, electronics, etc.) of consumer goods and/or may be specific to one category of consumer goods or to one seller S. After performing the electronic search, the buyer B may then select the specific consumer good using a user interface of an electronic device.

Referring still to FIG. 2G, Block 200* indicates that the buyer B may submit an offer to the electronic exchange 100 to purchase the specific consumer good at a buyer-determined price. Additionally, Block 201′ indicates that the electronic exchange 100 receives the offer from the buyer B. Accordingly, the buyer B selects (Block 200) the specific consumer good and submits (Block 200*) the offer for the specific consumer good before the electronic exchange 100 receives (Block 201′) the offer for the specific consumer good. The specific consumer good may have a specific SKU and/or UPC. In other words, the offer received (Block 201′) by the electronic exchange 100 from the buyer B is for a specific consumer good rather than for any one of a number of consumer goods that fit a general description (e.g., a size-twelve brown dress shoe).

Referring now to FIG. 2H, FIG. 2H includes Blocks 200*, 201′, 202, and 203 of FIG. 2G. FIG. 2H further includes Block 200′, which is a modification of Block 200 of FIG. 2G. Block 200′ indicates that a seller S suggests a consumer good to a buyer B. For example, if the buyer B has already made an offer to purchase a golf club, then the seller S may electronically suggest that the buyer B make an offer to purchase a comparable golf club. The suggestion may be displayed to the buyer B in an email or in an indication on the seller website 116, such as by displaying a “Make An Offer” button to the buyer B. The comparable golf club may be a similar golf club by the same manufacturer or by a different manufacturer, and will have a different SKU and UPC from the golf club for which the buyer B has already made an offer.

Although Block 200′ indicates that a seller S suggests a consumer good to a buyer B, it will be understood that the electronic exchange 100 and/or a third party (e.g., a financial institution) may additionally or alternatively suggest the consumer good to the buyer B. For example, the electronic exchange 100 may provide a suggestion to the buyer B via email or via an indication on the search website 115. In another example, the third party may provide a suggestion to the buyer B via email or via an indication on the third party website 117. Moreover, in some embodiments, the consumer good may be suggested/displayed to the buyer B merely because the seller S wants to promote the sale of the consumer good, irrespective of whether the buyer B has already made an offer to purchase a comparable consumer good. Accordingly, if the electronic exchange 100 receives (Block 201′) the offer from the buyer B to purchase the suggested consumer good, then the offer will be for the specific consumer good that was suggested (Block 200′) to the buyer B, rather than for any one of a number of consumer goods that fit a general description (e.g., a size-twelve brown dress shoe).

Referring now to FIG. 2I, a diagram is provided illustrating a transaction between a buyer B and a seller S of FIG. 1A, according to various embodiments. In particular, FIG. 2I illustrates that the buyer B₁ submits an offer to purchase a consumer good at a buyer-determined price to the electronic exchange 100 using one of the channels 114-117 illustrated in FIG. 1D. If the electronic exchange 100 determines that the inventory I_{I} of the seller S₁ includes the consumer good, then the electronic exchange 100 may transmit the offer to the seller S₁. If the seller S₁ accepts the offer, then the seller S₁ may transmit its acceptance of the offer to the electronic exchange 100, which may then provide an indication to the buyer B₁ that the seller S₁ has accepted the buyer B₁'s offer. After receiving the indication of the seller S₁'s acceptance, the buyer B₁ may submit payment information for the consumer good to the seller S₁. In particular, FIG. 2I illustrates that the payment information may bypass the electronic exchange 100. The payment information may include credit card information, shipping address information, online account information, and/or the like.

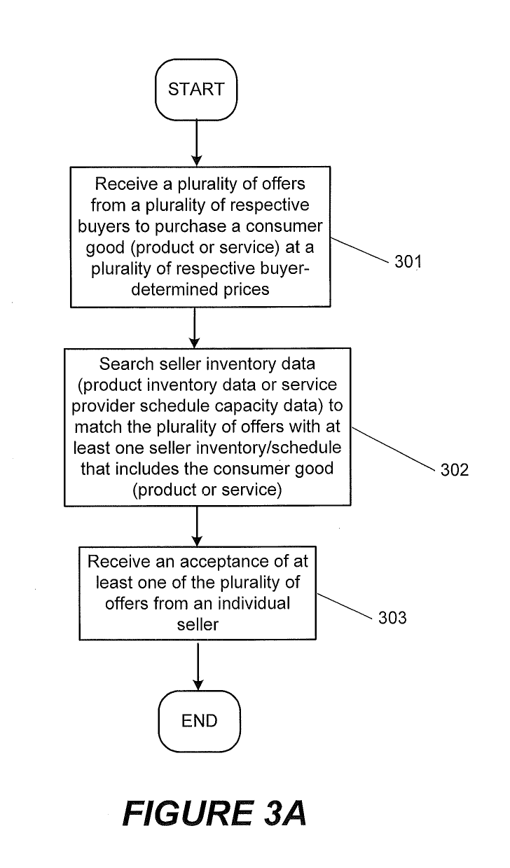

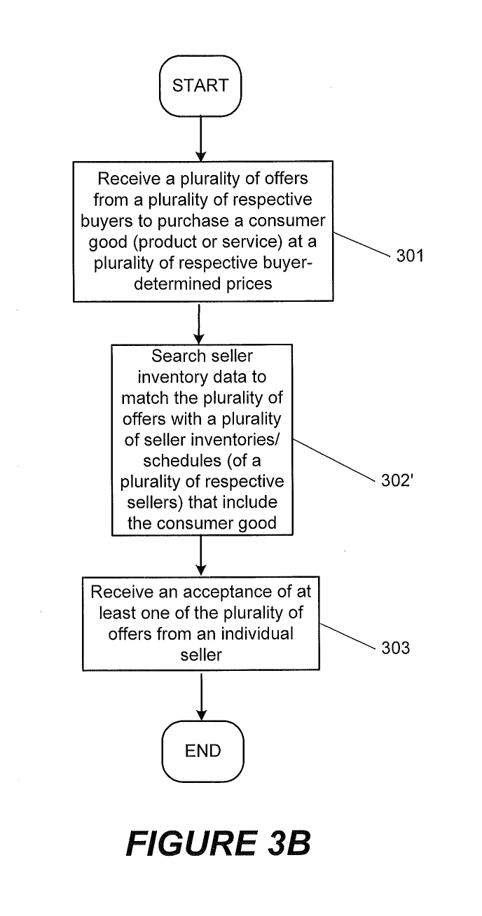

It will be understood that the operations of the electronic exchange 100 described herein may include a plurality of the buyers B₁-Bₙ and/or a plurality of the sellers S₁-Sₙ. For example, FIGS. 3A and 3B are flowcharts illustrating operations of the electronic exchange 100 of FIG. 1A including receiving a plurality of offers at the electronic exchange 100, according to various embodiments. In particular, FIG. 3A illustrates receiving at the electronic exchange 100 a plurality of offers from a plurality of respective buyers B₁-Bₙ to purchase a consumer good at a plurality of respective buyer-determined prices (Block 301). For example, a plurality of the buyers B₁-Bₙ may submit offers for the same consumer good having the same SKU and/or UPC. The operations of the electronic exchange 100 may further include searching seller inventory data from at least one database to match the plurality of offers with at least one seller inventory (among the inventories I₁-Iₙ) that includes the consumer good (Block 302). Additionally, the operations of the electronic exchange 100 may include receiving at the electronic exchange 100 an acceptance of at least one of the plurality of offers from an individual seller S whose inventory I includes the consumer good (Block 303). In other words, the seller S may accept only one of the plurality of offers, or may alternatively accept more than one of the plurality of offers. For example, the seller S may accept only the highest-priced offer among the plurality of offers.

Referring now to FIG. 3B, FIG. 3B includes Blocks 301 and 303 of FIG. 3A, and further includes Block 302′, which is a modification of Block 302 of FIG. 3A. In particular Block 302′ of FIG. 3B illustrates that searching seller inventory data includes searching seller inventory data to match the plurality of offers with a plurality of seller inventories that include the consumer good. The plurality of seller inventories may be included among the inventories I₁-Iₙ of the different respective sellers S₁-Sₙ. As an example, if buyers B₁-B₃ have submitted respective offers to purchase the consumer good at respective buyer-determined prices, and each of the inventories I₁ and I₂ includes the consumer good, then the electronic exchange 100 may match the offers with each of the inventories I₁ and I₂, and may notify the sellers S₁ and S₂ corresponding to the inventories I₁ and I₂ of each of the offers.

Accordingly, according to various embodiments of the present inventive concepts, operations of facilitating a buyer-driven transaction may include a buyer B submitting an offer to purchase a consumer good at a buyer-determined price to a electronic exchange. For example, a buyer B may submit an offer to purchase a pair of running shoes having a specific SKU/UPC at a buyer-determined price of $40.00 to the electronic exchange 100. After the buyer B submits the offer for the running shoes, the electronic exchange 100 may search seller inventory data from at least one database to match the offer with at least one seller inventory (among the inventories I₁-Iₙ) that includes the running shoes. As an example, the electronic exchange 100 may search its own database(s) for seller inventory data. In particular, the electronic exchange 100 may search the electronic order book 113 included in the electronic exchange 100 for seller inventory data. Additionally or alternatively, the electronic exchange 100 may search for seller inventory data that is external to the electronic exchange 100 by using the inventory interface 122 that is included in (and/or connected to) the electronic exchange 100 and that receives seller inventory data corresponding to one or more sellers S₁-Sₙ. For example, the inventory interface 122 may be used to search for seller inventory data directly from one or more seller-affiliated inventory databases. As an example, the seller S₁ may be a clothing company whose inventory I₁ is stored in one inventory database, and the seller S₂ may be a shoe company whose inventory I₂ is stored in the same inventory database or another inventory database. The inventory interface 122 may thus be used to search the inventory database (or databases) corresponding to the inventory I₁ and/or the inventory I₂ for the running shoes that the buyer B wants to buy.

Moreover, the electronic exchange 100 may receive an acceptance of the buyer B's offer from an individual seller S. As an example, the individual seller S may be the seller S₂ whose inventory I₂ is included among seller inventories matched with the offer. If the seller S₂ (e.g., the shoe company) is willing to accept the buyer B's offer to pay $40.00 for the running shoes, then the seller S₂ may submit an acceptance to the electronic exchange 100. Accordingly, the electronic exchange 100 may operate as an exchange platform that matches the willingness-to-pay of one or more buyers (among the buyers B₁-Bₙ) with the willingness-to-sell of one or more sellers (among the sellers S₁-Sₙ).

As described herein, the electronic exchange 100 may link a buyer B to one seller S or to a plurality of sellers S₁-Sₙ. Additionally, the electronic exchange 100 may link a plurality of buyers B₁-Bₙ to one seller S or to a plurality of sellers S₁-Sₙ. As an example, five (5) buyers B₁-B₅ may submit five (5) independent offers for the same consumer good (e.g., a pair of running shoes having a specific SKU/UPC) to the electronic exchange 100. After the five (5) offers are matched with at least one seller inventory I, an individual seller S may submit its acceptance of at least one of the five (5) offers to the electronic exchange 100. For example, if the individual seller S's inventory I includes at least five (5) units of the running shoes, then the individual seller S may be presented with a user interface button that allows the individual seller S to accept all five (5) of the offers with a single click/touch. As an example, the user interface button may be on a website or mobile application or in an email.

According to some embodiments of the present inventive concepts, the electronic exchange 100 described herein may further include a demand analytics processor that is configured to optimize transactions for buyers B₁-Bₙ and/or sellers S₁-Sₙ. For example, the demand analytics processor may be configured to use one or more filters to optimize a plurality of offers from the buyers B₁-Bₙ that match a seller inventory I of a particular seller S. This optimization may be based on a demand analytics preference of the seller S for a consumer good. The demand analytics preference may be a preference regarding profit/profit margin, raw price, time of receiving an offer, etc. The optimization may include determining, using the demand analytics preference, whether to make the plurality of offers available to the seller S and/or how to display the plurality of offers to the seller S. In addition to optimizing offers for the seller S, the demand analytics processor may be further configured to determine a suggestion for a buyer B of a comparable consumer good with respect to the consumer good and/or a complementary consumer good with respect to the consumer good. For example, if the buyer B makes an offer for a golf club, then the demand analytics processor may suggest that the buyer B make an offer to purchase a comparable golf club. The comparable golf club may be a similar golf club by the same manufacturer or by a different manufacturer.

In the specification, various embodiments of the inventive concepts have been disclosed and, although specific terms are employed, they are used in a generic and descriptive sense only and not for purposes of limitation. Those skilled in the art will readily appreciate that many modifications are possible for the disclosed embodiments without materially departing from the teachings and advantages of the inventive concepts. The inventive concepts are defined by the following claims, with equivalents of the claims to be included therein.

What is claimed is:

1. A method of facilitating a buyer-driven transaction, comprising:
receiving at an electronic exchange an offer from a buyer to purchase a product or service at a buyer-determined price;
searching seller inventory data or seller capacity data from at least one database to match the offer with at least one seller inventory or seller schedule that includes the product or service; and
receiving at the electronic exchange an acceptance of the offer from an individual seller whose inventory or schedule is included among the at least one seller inventory or seller schedule.

2. The method of claim 1, wherein the product or service comprises a specific product or service selected by the buyer after the buyer performs an electronic search for one or more products or services.

3. The method of claim 1, wherein the product or service comprises a specific product or service electronically suggested to the buyer by at least one of the electronic exchange, the individual seller, and a third party.

4. The method of claim 1, further comprising:
transmitting an indication to the buyer that the offer has been accepted by the individual seller.

5. The method of claim 4, further comprising:
contact between the buyer and the individual seller to complete the transaction, wherein the contact includes a transmission of payment information from the buyer to at least one of the electronic exchange, individual seller, and a third party.

6. The method of claim 4, wherein identification of any seller corresponding to a respective one of the at least one inventory or schedule remains undisclosed to the buyer before the transmittal of the indication to the buyer that the offer to purchase the product or service at the buyer-determined price has been accepted by the individual seller.

7. The method of claim 1, wherein the at least one inventory or schedule comprises a plurality of inventories or schedules corresponding to a plurality of respective sellers.

8. The method of claim 1, wherein searching the seller inventory data to match the offer with the at least one seller inventory comprises searching using at least one of a Stock-Keeping Unit (SKU), a Universal Product Code (UPC), a Global Trade Identifier Number (GTIN), and another unique product or service identifier corresponding to the product or service.

9. The method of claim 1, further comprising:
notifying each seller corresponding to a respective one of the at least one inventory or schedule that the offer to purchase the product or service at the buyer-determined price has been submitted; and
providing each seller corresponding to a respective one of the at least one inventory or schedule with an option to accept the offer to purchase the product or service at the buyer-determined price with a single selection of an acceptance button.

10. The method of claim 1, further comprising:
automatically accepting or rejecting the offer to purchase the product or service at the buyer-determined price using a seller selection algorithm.

11. The method of claim 1, wherein receiving the offer to purchase the product or service at the buyer-determined price comprises receiving the offer at the electronic exchange via one of the following channels: a mobile device, a search website of the electronic exchange, a website of the individual seller, a third party shopping platform, and another affiliated third party.

12. The method of claim 1, wherein the offer from the buyer to purchase the product or service at the buyer-determined price comprises an unconditional offer from the buyer.

13. A method of facilitating a buyer-driven transaction, comprising:
receiving at an electronic exchange an offer from a buyer to purchase a product or service at a buyer-determined price;
searching seller inventory data or capacity data from at least one database to match the offer with a plurality of seller inventories or seller schedules that each include the product or service; and
receiving at the electronic exchange an acceptance of the offer from an individual seller whose inventory is included among the plurality of seller inventories.

14. The method of claim 13, wherein the plurality of seller inventories or schedules corresponds to a plurality of different respective sellers.

15. The method of claim 13, further comprising:
transmitting an indication to the buyer that the offer has been accepted by the individual seller.

16. The method of claim 13, wherein searching the seller inventory data or capacity data to match the offer with the plurality of seller inventories or schedules comprises searching using at least one of a Stock-Keeping Unit (SKU), a Universal Product Code (UPC), a Global Trade Identifier Number (GTIN), and another unique product or service identifier corresponding to the product or service.

17. The method of claim 13, wherein the offer from the buyer to purchase the product or service at the buyer-determined price comprises an unconditional offer from the buyer.

18. A method of facilitating a buyer-driven transaction, comprising:
receiving at an electronic exchange a plurality of offers from a plurality of respective buyers to purchase a product or service at a plurality of respective buyer-determined prices;
searching seller inventory data or seller capacity data from at least one database to match the plurality of offers with at least one seller inventory or seller schedule that includes the product or service; and
receiving at the electronic exchange an acceptance of at least one of the plurality of offers from an individual seller whose inventory or schedule is included among the at least one seller inventory or schedule.

19. The method of claim 18, wherein the at least one seller inventory or schedule comprises a plurality of seller inventories or schedules that correspond to a plurality of different respective sellers.

20. The method of claim 18, wherein receiving the plurality of offers to purchase the product or service at the plurality of respective buyer-determined prices comprises receiving the plurality of offers at the electronic exchange via at least one of the following channels: a mobile device, a search website of the electronic exchange, a website of the individual seller, a third party shopping platform, and another affiliated third party.

21. The method of claim 18, wherein the plurality of offers from the plurality of respective buyers comprise a plurality of unconditional offers from the plurality of respective buyers.

22. An electronic exchange for facilitating a buyer-driven transaction, comprising:
a network interface configured to communicate with a network;
an electronic order book configured to receive, via the network interface, an offer from a buyer to purchase a product or service at a buyer-determined price, and to receive, via the network interface, an acceptance of the offer from an individual seller; and
an inventory processor configured to search seller inventory data or seller capacity data to match the offer with at least one seller inventory or seller schedule that includes the product or service, wherein an inventory or schedule of the individual seller is included among the at least one seller inventory or schedule.

23. The electronic exchange of claim 22, wherein the network interface further comprises:
a buyer interface that is configured to receive the offer via one of the following channels connected between the buyer and the electronic order book: a mobile device, a search website of the electronic exchange, a website of the individual seller, a third party shopping platform, and another affiliated third party; and
an inventory interface that is configured to receive the seller inventory data or seller capacity data from a plurality of different sellers and to supply the seller inventory data or seller capacity data to the electronic order book.

24. The electronic exchange of claim 22, wherein:
the electronic order book is further configured to receive, via the network interface, a plurality of offers from a plurality of respective buyers to purchase the product or service at a plurality of respective buyer-determined prices;
the inventory processor is further configured to search the seller inventory data or seller capacity data to match the plurality of offers with the at least one seller inventory or seller schedule that includes the product or service; and
the electronic exchange is further configured to receive, via the network interface, an acceptance of at least one of the plurality of offers from the individual seller.

25. The electronic exchange of claim 22, wherein the inventory processor is configured to search the electronic order book for the seller inventory data or seller capacity data to match the plurality of offers with the at least one seller inventory or seller schedule that includes the product or service.

26. The electronic exchange of claim 22, wherein the inventory processor is configured to search a database external to the electronic exchange for the seller inventory data or seller capacity data to match the plurality of offers with the at least one seller inventory or seller schedule that includes the product or service.

27. The electronic exchange of claim 22, wherein the product or service comprises a specific product or service selected by the buyer after the buyer performs an electronic search for one or more products or services.

28. The electronic exchange of claim 22, wherein the product or service comprises a specific product or service electronically suggested to the buyer by at least one of the electronic exchange, the individual seller, and a third party.

29. The electronic exchange of claim 22, wherein the offer from the buyer to purchase the product or service at the buyer-determined price comprises an unconditional offer from the buyer.
